(19) United States
(12) Patent Application Publication
(10) Pub. No.: US 2026/0366476 A1
(43) Pub. Date: Nov. 19, 2026

(54) VAPOR SEPARATOR TANK

(71) Applicant: MIKUNI CORPORATION, Tokyo (JP)

(72) Inventor: Takumi Oikawa, Odawara-shi (JP)

(21) Appl. No.: 19/647,114

(22) Filed: Apr. 14, 2026

(30) Foreign Application Priority Data
May 15, 2025 (JP) 2025-082112

(51) Int. Cl. F02M 37/54; F02M 37/00; F02M 37/18

(52) U.S. Cl. CPC F02M 37/54; F02M 37/0052; F02M 37/18

(57) ABSTRACT

A VST includes a fuel storage chamber, a first pump and a second pump that pressure-feed liquid fuel stored in the fuel storage chamber, a pressure regulator that returns a part of the liquid fuel back to the fuel storage chamber, a flow path that communicates with a return port of the pressure regulator and that also has an opening portion opening toward the liquid surface of the liquid fuel stored in the fuel storage chamber, and a hollow cap detachably mounted within the flow path, protruding from the opening portion toward the fuel storage chamber, and communicating with the flow path. A plurality of ejection ports opening in directions other than toward the liquid surface of the liquid fuel is formed in the cap.

### BACKGROUND OF THE INVENTION

### Field of the Invention

The present invention relates to a vapor separator tank having a pressure regulator.

### Description of the Related Art

Conventionally, there has been known a technology related to a vapor separator tank having a pressure regulator and a gas-liquid separation function of separating gas, such as evaporated gas and bubbles generated from liquid fuel. For example, Japanese Patent Laid-Open No. 2010-007519 describes a vapor separator tank in which a pipe section connected to a discharge section of a high-pressure pump has a pressure regulator installed therein for releasing fuel into a tank section so as to regulate the pressure in the pipe section.

However, in the vapor separator tank described in Japanese Patent Laid-Open No. 2010-007519, fuel flowing down from the pressure regulator to a fuel storage chamber may cause bubbles to form on the liquid surface and in the liquid of the liquid fuel. In such a case, a pump for suctioning the liquid fuel may also suction the bubbles, for example, potentially causing performance degradation of the vapor separator tank.

The present invention has been made in view of the foregoing problem, and an object of the present invention is to provide a vapor separator tank capable of suppressing performance degradation, which would occur if liquid fuel directly flows down onto a liquid surface of a fuel storage chamber from a pressure regulator, using a simple structure.

### SUMMARY OF THE INVENTION

To achieve the foregoing object, a vapor separator tank of the present invention is a vapor separator tank for separating gas from liquid fuel to be supplied to an internal combustion engine, including a casing in which a fuel storage chamber that stores the liquid fuel is formed; a pump that pressure-feeds the liquid fuel stored in the fuel storage chamber; a pressure regulator that returns a part of the liquid fuel, pressure-fed by the pump, back to the fuel storage chamber according to discharge pressure of the pump; a flow path formed in the casing, the flow path communicating with a return port of the pressure regulator, and having an opening portion opening toward a liquid surface of the liquid fuel stored in the fuel storage chamber; and a hollow cap detachably mounted within the flow path, the hollow cap projecting from the opening portion toward the fuel storage chamber, and communicating with the flow path, in which at least one ejection port opening in a direction other than toward the liquid surface of the liquid fuel is formed in the cap.

The cap may include a bottom-closed cylindrical main body portion, and a flange portion projecting radially outward from the main body portion, the main body portion may be inserted into the flow path such that the main body portion protrudes toward the fuel storage chamber via the opening portion, and the flange portion may be placed on a peripheral edge portion of the opening portion.

The ejection port may include a plurality of ejection ports that are formed to open in different predetermined directions.

The ejection port may be a single opening that opens in a predetermined direction.

The ejection port may open in an obliquely upward direction.

The casing may have a boss portion which extends downward from a ceiling portion and in which a discharge flow path communicating with a discharge port of the pump is formed, the cap may be arranged close to the boss portion, and at least a part of the ejection port may open toward the boss portion.

According to the vapor separator tank of the present invention, it is possible to suppress performance degradation that would occur if liquid fuel directly flows down onto a liquid surface of a fuel storage chamber from a pressure regulator.

### BRIEF DESCRIPTION OF THE DRAWINGS

FIG. 1 is a schematic perspective view of a vapor separator tank;

FIG. 2 is a longitudinal sectional view of the vapor separator tank in the XZ plane along line A-A of FIG. 1;

FIG. 3 is a longitudinal sectional view of the vapor separator tank in the YZ plane along line B-B of FIG. 2;

FIG. 4 is a perspective view of a pressure regulator;

FIG. 5 is a schematic sectional view of a region around a cap of an upper case;

FIG. 6 is a perspective view of a cap of a first embodiment;

FIG. 7 is a perspective view of a cap of a second embodiment;

FIG. 8 is a perspective view of a cap of a third embodiment;

FIG. 9 is a perspective view of a cap of a fourth embodiment; and

FIG. 10 is a perspective view of a cap of a fifth embodiment.

### DETAILED DESCRIPTION OF THE INVENTION

Hereinafter, an embodiment of the present invention will be described based on the drawings. In the following description, the vertical direction shall be referred to as the "Z-direction," one horizontal direction perpendicular to the "Z-direction" shall be referred to as the "X-direction," and a direction perpendicular to both the X-direction and the Z-direction shall be referred to as the "Y-direction," as appropriate.

### First embodiment

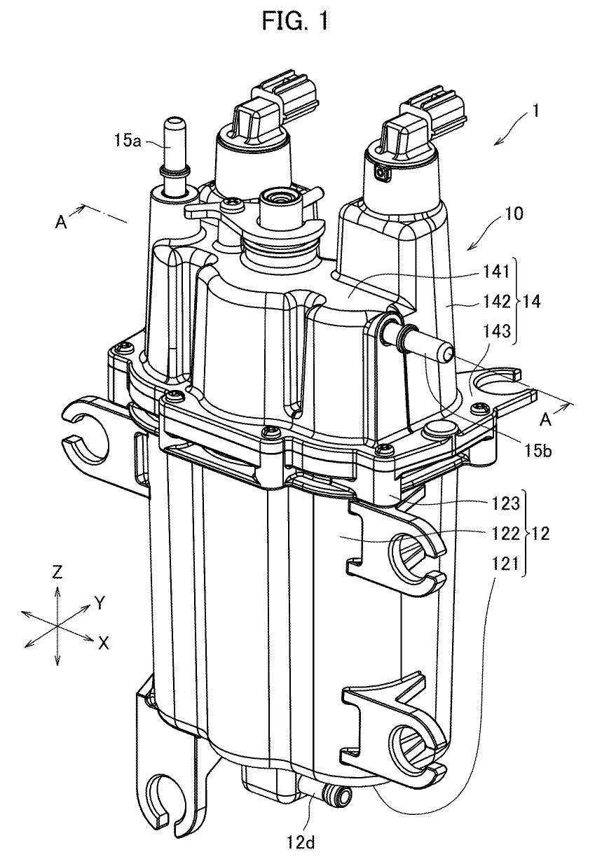

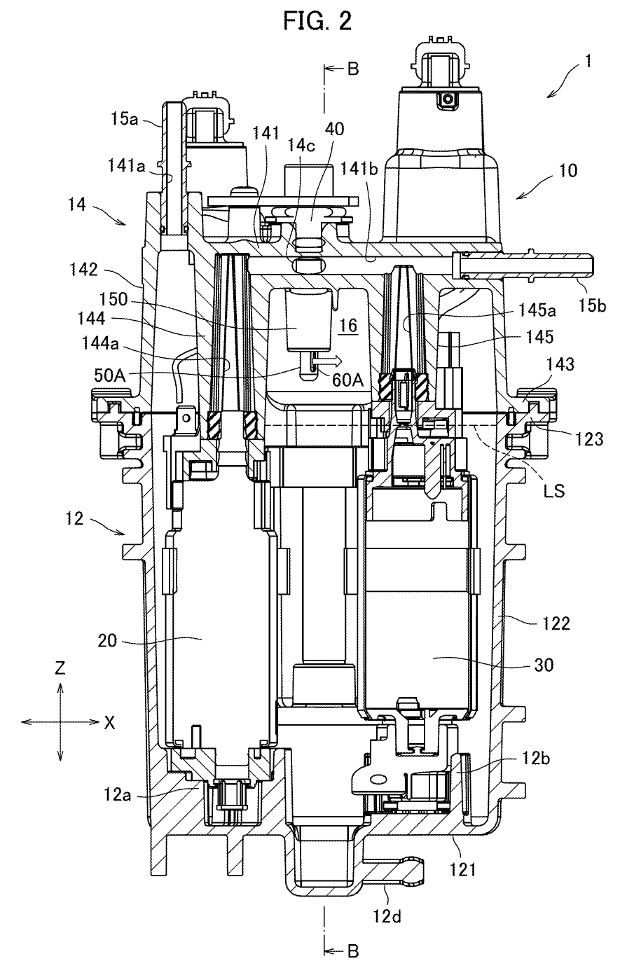

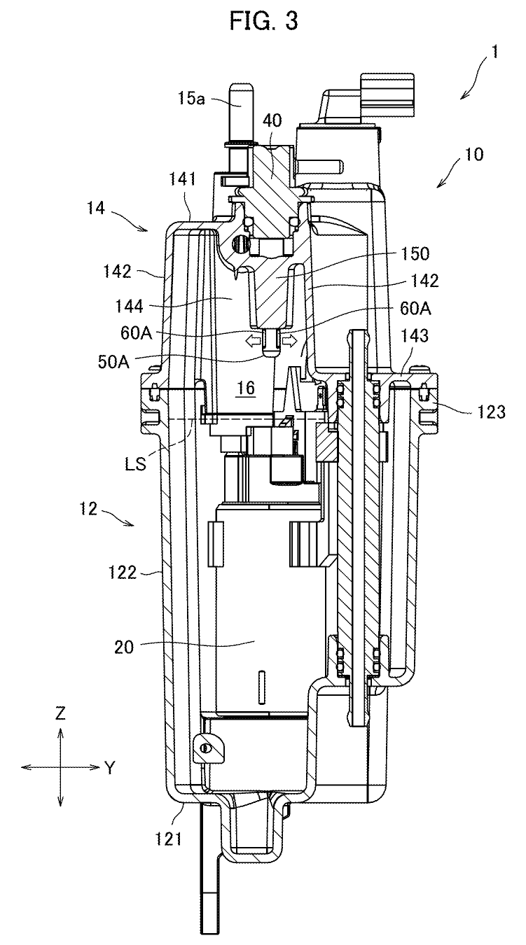

FIG. 1 is a schematic perspective view of a vapor separator tank. FIG. 2 is a longitudinal sectional view of the vapor separator tank in the XZ plane along line A-A of FIG. 1. FIG. 3 is a longitudinal sectional view of the vapor separator tank in the YZ plane along line B-B of FIG. 2. A vapor separator tank 1 (hereinafter referred to as "VST 1") is applied to an outboard motor (not illustrated) mounted on a vessel, for example. The VST 1 is connected between an internal combustion engine serving as a power source of the outboard motor and a fuel tank for storing liquid fuel, and has a function of temporarily storing liquid fuel to be supplied to the internal combustion engine, and a gas-liquid separation function of separating gas, such as evaporated gas and bubbles generated from the liquid fuel. As illustrated in FIG. 2, the VST 1 includes a casing 10, a first pump (i.e., pump) 20, a second pump (i.e., pump) 30, and a pressure regulator 40.

The casing 10 includes a lower case 12 and an upper case 14. As illustrated in FIGS. 2 and 3, the lower case 12 is a container-shaped member that includes a bottom face portion 121, a side wall portion 122 extending upward from the bottom face portion 121, and a fastening face portion 123 projecting outward from the upper end of the side wall portion 122, and has an open upper portion. A space enclosed by the bottom face portion 121 and the side wall portion 122 of the lower case 12 corresponds to a fuel storage chamber 16 for storing liquid fuel.

The bottom face portion 121 of the lower case 12 has a first support portion 12a formed thereon protruding in a cylindrical shape to support the bottom portion of the first pump 20 via a spacer, and a second support portion 12b protruding in a cylindrical shape to support the bottom portion of the second pump 30 via a spacer. Further, the lower portion of the lower case 12 has a drain port 12d formed therein for discharging fuel during maintenance or when the internal combustion engine is not used for a long period during off-season.

As illustrated in FIGS. 1 - 3, the upper case 14 is a cover member that closes the open upper portion of the lower case 12. The upper case 14 includes a ceiling portion 141, a side wall portion 142 extending downward from the ceiling portion 141, and a fastening face portion 143 projecting outward from the lower end of the side wall portion 142. The lower case 12 and the upper case 14 abut each other at their fastening face portions 123 and 143, and are fastened together with a plurality of fasteners.

The ceiling portion 141 of the upper case 14 is provided with a pipe 15a in which a fuel inlet passage 141a to be supplied with liquid fuel from a fuel tank by a pump (not illustrated) arranged outside the VST 1 is formed. In addition, the ceiling portion 141 has a first boss portion (i.e., boss portion) 144 and a second boss portion (i.e., boss portion) 145 each extending downward in a columnar shape formed thereon. The first boss portion 144 has a first discharge flow path (i.e., discharge flow path) 144a formed therein connected to a discharge port of the first pump 20. The second boss portion 145 has a second discharge flow path (i.e., discharge flow path) 145a formed therein connected to a discharge port of the second pump 30. Further, the ceiling portion 141 has a fuel outlet passage 141b formed therein communicating with the first discharge flow path 144a and the second discharge flow path 145a. The fuel outlet passage 141b is connected to a pipe on the side of the internal combustion engine, which is arranged downstream of the VST 1, via a pipe 15b.

The first pump 20 and the second pump 30 are pumps, mounted within the casing 10, for pressure-feeding liquid fuel stored in the fuel storage chamber 16. Each of suction ports of the first pump 20 and the second pump 30 has connected thereto a filter for filtering liquid fuel in the fuel storage chamber 16. The liquid fuel discharged from the first pump 20 and the second pump 30 is pressure-fed to the internal combustion engine via the fuel outlet passage 141b. The VST 1 of this embodiment has a sealed structure without a vent passage for allowing the internal space to communicate with the external space. Thus, vapor in the fuel storage chamber 16 is suctioned into the second pump 30 via a suction pipe (not illustrated) connected to the suction port of the second pump 30, and is processed by being liquefied within the second pump 30. The amount of liquid fuel to be stored in the VST 1 can be adjusted by controlling the flow rate of liquid fuel supplied to the VST 1 from a pump (not illustrated) and the flow rate of liquid fuel discharged from the VST 1 by the first pump 20 and the second pump 30.

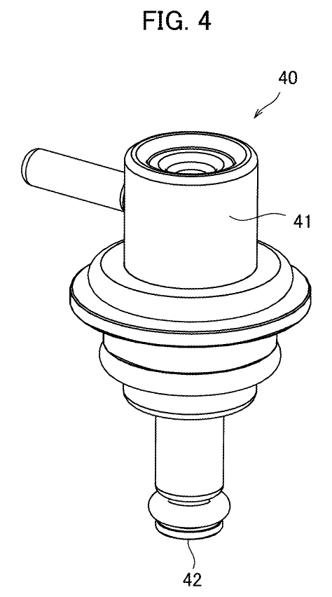

FIG. 4 is a perspective view of the pressure regulator 40. The pressure regulator 40 is supported by the upper case 14, and is connected to a through-hole 14c (FIG. 2) serving as a relief flow path that communicates with an intermediate portion of the fuel outlet passage 141b. The pressure regulator 40 includes, within its substantially cylindrical case 41, a valve element, a valve seat portion, and a spring (which are not illustrated), for example, and opens in response to an increase in the pressure of fuel flowing into the fuel outlet passage 141b, and then returns excess fuel back to the fuel storage chamber 16 through a return port 42. Accordingly, the discharge pressure of the first pump 20 and the second pump 30, that is, the pressure of liquid fuel to be supplied to the internal combustion engine is regulated to be constant.

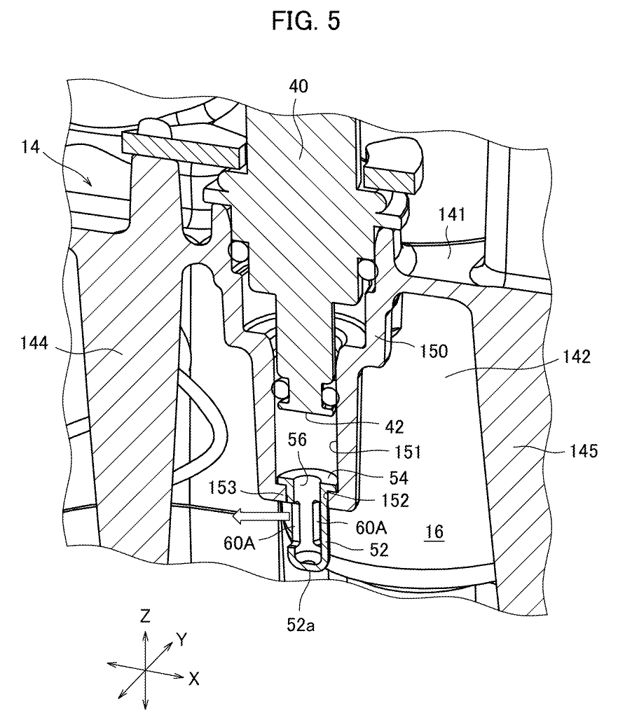

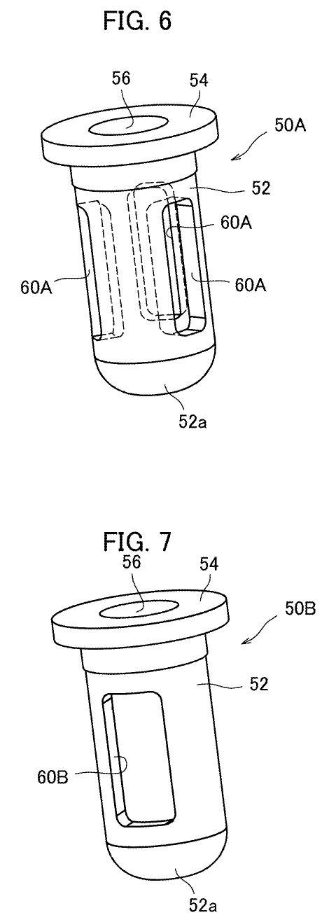

Herein, if liquid fuel flows down from the pressure regulator 40 into the fuel storage chamber 16, bubbles may be generated on a liquid surface LS (indicated by a dashed line in FIGS. 2 and 3) of the liquid fuel. This can cause the pump to suction the bubbles together with the liquid fuel, potentially leading to performance degradation of the vapor separator tank. Therefore, the VST 1 has a cap 50A provided in a liquid fuel outlet portion (i.e., an opening portion 152 described later) of the pressure regulator 40. Hereinafter, the cap 50A of the first embodiment will be described with reference to the drawings. FIG. 5 is a schematic sectional view of a region around the cap 50A of the upper case 14. FIG. 6 is a perspective view of the cap 50A of the first embodiment.

First, as illustrated in FIG. 5, the ceiling portion 141 of the upper case 14 has a housing portion 150 formed therein at a position between the first boss portion 144 and the second boss portion 145. The housing portion 150 protrudes in a cylindrical shape upward and downward from the ceiling portion 141, and the pressure regulator 40 is fitted inside the housing portion 150. The housing portion 150 has a flow path 151 formed therein extending in the vertical direction. The lower end of the flow path 151 is provided with the opening portion 152 that opens toward the liquid surface LS of the liquid fuel stored in the fuel storage chamber 16. The lower end portion of the pressure regulator 40 is fitted onto the inner peripheral surface of the flow path 151 via a sealing member, and the return port 42 for liquid fuel formed at the lower end of the pressure regulator 40 is located above the opening portion 152.

The cap 50A is attached to the opening portion 152 of the flow path 151. Specifically, as illustrated in FIGS. 5 and 6, the cap 50A is formed as a bottom-closed tubular member, and includes a hollow cylindrical main body portion 52 and a flange portion 54 formed at one end of the main body portion 52 in the axial direction. The cap 50A has a cap internal flow path 56 formed therein extending in the axial direction. The cap internal flow path 56 communicates with the flow path 151 by opening at an end face on the flange portion 54 side. Note that a bottom portion 52a is formed at an end portion of the main body portion 52 on the side opposite to the flange portion 54, and thus, the lower end of the cap internal flow path 56 is closed by the bottom portion 52a.

The main body portion 52 is formed to have a diameter smaller than those of the flow path 151 and the opening portion 152 described above. Meanwhile, the flange portion 54 is an annular portion projecting radially outward from the main body portion 52, and is formed to have a diameter smaller than that of the flow path 151 and larger than that of the opening portion 152. In addition, the opening portion 152 has a reduced diameter compared to that of the flow path 151, and an annular peripheral edge portion 153 (i.e., the bottom portion of the housing portion 150) is formed around the opening portion 152. The cap 50A is inserted into the flow path 151 such that the main body portion 52 protrudes from the opening portion 152 toward the fuel storage chamber 16, and the flange portion 54 is placed on the upper face of the peripheral edge portion 153. At this time, the cap 50A is positioned relative to the casing 10 as the main body portion 52 is press-fitted into the opening portion 152. Note that the operations of attaching and detaching the cap 50A to/from the casing 10 are performed with the pressure regulator 40 removed.

A side face portion, which extends in the axial direction, of the main body portion 52 has a plurality of (i.e., three in this embodiment) ejection ports 60A formed therein communicating with the cap internal flow path 56. Each ejection port 60A is formed in a portion of the main body portion 52 protruding toward the fuel storage chamber 16 in a state where the cap 50A is attached to the casing 10. The ejection ports 60A are provided at intervals in the circumferential direction, and open in different predetermined directions. Each ejection port 60A of the first embodiment is a long through-hole extending along the axial direction.

Accordingly, liquid fuel discharged from the return port 42 of the pressure regulator 40 flows into the cap internal flow path 56 of the cap 50A through the flow path 151, and is then ejected into the fuel storage chamber 16 through each ejection port 60A. At this time, as each ejection port 60A is formed in the side face portion of the cap 50A (i.e., the main body portion 52), the liquid fuel is ejected mainly in the radial direction of the cap 50A (i.e., the X-direction or the Y-direction in the drawings), as schematically indicated by a hollow arrow in FIGS. 2, 3, and 5. Consequently, the liquid fuel ejected from the cap 50A is diffused (i.e., dispersed) through the ejection ports 60A in a plurality of directions, so that the amount of liquid fuel directly flowing down onto the liquid surface LS per predetermined time decreases compared to a case where it directly flows down onto the liquid surface LS from the opening portion 152. Further, as the liquid fuel hits structural elements arranged near the cap 50A within the fuel storage chamber 16, such as the side wall portion 142, the first boss portion 144, and the second boss portion 145 of the upper case 14, it becomes easier for the liquid fuel to flow downward onto the liquid surface LS along the structural elements. This can suppress the generation of bubbles near the liquid surface LS.

As described above, the VST 1 of the first embodiment includes the casing 10 in which the fuel storage chamber 16 that stores liquid fuel is formed; the first pump (i.e., pump) 20 and the second pump (i.e., pump) 30 that pressure-feed the liquid fuel stored in the fuel storage chamber 16; the pressure regulator 40 that returns a part of the liquid fuel, pressure-fed from the first pump 20 and the second pump 30, back to the fuel storage chamber 16 according to the discharge pressure of the first pump 20 and the second pump 30; the flow path 151 that is formed in the casing 10 and communicates with the return port 42 of the pressure regulator 40, and also has the opening portion 152 opening toward the liquid surface of the liquid fuel stored in the fuel storage chamber 16; and the hollow cap 50A that is detachably mounted within the flow path 151, protrudes from the opening portion 152 toward the fuel storage chamber 16, and communicates with the flow path 151. The plurality of ejection ports 60A opening in directions other than toward the liquid surface LS of the liquid fuel is formed in the portion (i.e., the main body portion 52) of the cap 50A protruding from the opening portion 152 toward the fuel storage chamber 16.

According to such a configuration, as described above, liquid fuel from the pressure regulator 40 can be diffused and discharged through each ejection port 60A of the cap 50A in a direction other than toward the liquid surface LS. Thus, it is possible to suppress a large amount of liquid fuel from directly flowing down onto the liquid surface LS in a short time, thereby suppressing the generation of bubbles near the liquid surface LS. Consequently, it is possible to suppress the suction of bubbles by the first pump 20 and the second pump 30, as well as an increase in internal pressure due to the generation of evaporated gas in the sealed VST 1. Further, it is also possible to suppress the unstable behavior of the liquid surface LS of the liquid fuel caused by the generation of bubbles. Thus, if a float mechanism for regulating the amount of liquid fuel to be supplied into the VST 1 according to the level of the liquid surface LS is provided, the operation of the float mechanism can be stabilized.

Moreover, since the cap 50A is detachably mounted within the flow path 151 of casing 10, the foregoing effects can be easily obtained by simply attaching the cap 50A to a conventional vapor separator tank in which liquid fuel flows down from the opening portion 152 toward the liquid surface LS. In addition, the direction of liquid fuel to be ejected through each ejection port 60A can be easily adjusted by simply adjusting the attachment angle (i.e., the angle of rotation around the axis) of the cap 50A relative to the casing 10. As described above, according to the VST 1 of the embodiment, performance degradation, which would occur if liquid fuel directly flows down onto the liquid surface LS of the fuel storage chamber 16 from the pressure regulator 40, can be controlled with a simple structure.

In addition, the cap 50A includes the bottom-closed cylindrical main body portion 52 and the flange portion 54 projecting radially outward from the main body portion 52. The main body portion 52 is inserted into the flow path 151 such that it protrudes toward the fuel storage chamber 16 via the opening portion 152, and the flange portion 54 is placed on the peripheral edge portion 153 of the opening portion 152. Such a configuration allows the cap 50A to be easily attached to and detached from the casing 10.

The plurality of ejection ports 60A are formed to open in different predetermined directions. Such a configuration allows liquid fuel from the ejection ports 60A to be diffused and ejected in a plurality of predetermined directions, and also allows for fine adjustment of the respective ejection directions and the respective ejection volumes of the liquid fuel.

In addition, the casing 10 has the first boss portion (i.e., boss portion) 144 which extends downward from the ceiling portion 141 and in which the first discharge flow path (i.e., discharge flow path) 144a communicating with the discharge port of the first pump 20 is formed, and the second boss portion (i.e., boss portion) 145 in which the second discharge flow path (i.e., discharge flow path) 145a communicating with the discharge port of the second pump 30 is formed. The cap 50A is arranged between and close to the first boss portion 144 and the second boss portion 145. More specifically, as illustrated in FIG. 3, the cap 50A is arranged such that at least a part of it overlaps the first boss portion 144 when viewed along the arrangement direction (i.e., X-direction) of the first boss portion 144, the second boss portion 145, and the cap 50A. A part of the ejection ports 60A (i.e., the ejection port 60A located on the left side in FIG. 5) opens toward the first boss portion 144.

Such a configuration allows liquid fuel ejected through the ejection port 60A to hit the first boss portion 144 more easily, thereby favorably suppressing the direct flow of the liquid fuel onto the liquid surface LS. In addition, since the pressure regulator 40 can be easily arranged near the first discharge flow path 144a and the second discharge flow path 145a, the cap 50A can also be easily arranged near the first boss portion 144 and the second boss portion 145.

### Second embodiment

FIG. 7 is a perspective view of a cap 50B of a second embodiment. The cap 50B has a single ejection port 60B instead of the plurality of ejection ports 60A of the first embodiment. The ejection port 60B is formed slightly larger than each ejection port 60A of the first embodiment to ensure a certain ejection flow rate. In this manner, the ejection port 60B may be a single opening that opens in a predetermined direction. Even with such a single opening, liquid fuel from the pressure regulator 40 can be ejected through the ejection port 60B in a direction other than toward the liquid surface LS, as in the first embodiment. This can suppress the direct flow of the liquid fuel onto the liquid surface LS, thereby suppressing the generation of bubbles near the liquid surface LS. In addition, it is possible to allow a predetermined amount of liquid fuel to be ejected in a predetermined direction by simply adjusting the angle at which the single ejection port 60B is oriented, that is, the angle of rotation of the cap 50B around the axis and the size of the ejection port 60B.

### Third embodiment

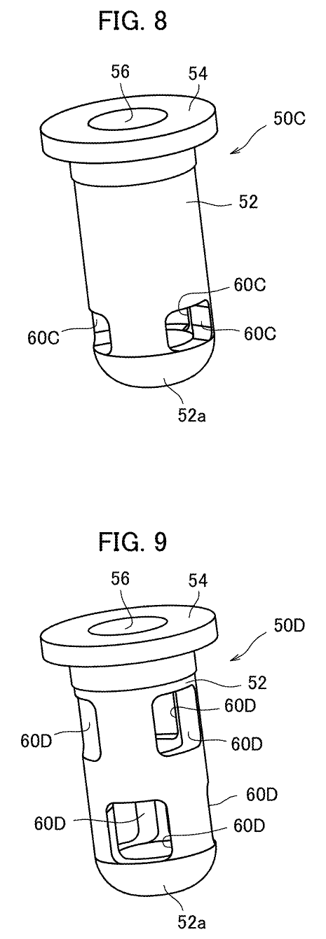

FIG. 8 is a perspective view of a cap 50C of a third embodiment. The cap 50C has a plurality of (i.e., three) ejection ports 60C instead of the plurality of ejection ports 60A of the first embodiment. The plurality of ejection ports 60C are provided at intervals in the circumferential direction such that they open in different predetermined directions, as with the plurality of ejection ports 60A. Note that each ejection port 60C is formed as a substantially rectangular through-hole near the bottom portion 52a of the main body portion 52. Even with such a plurality of ejection ports 60C, liquid fuel from the pressure regulator 40 can be diffused and discharged through the ejection ports 60C in directions other than toward the liquid surface LS, as in the first embodiment. This can suppress the direct flow of the liquid fuel onto the liquid surface LS, thereby suppressing the generation of bubbles near the liquid surface LS.

### Fourth embodiment

FIG. 9 is a perspective view of a cap 50D of a fourth embodiment. The cap 50D has a plurality of (i.e., six) ejection ports 60D instead of the plurality of ejection ports 60A of the first embodiment. The plurality of ejection ports 60D are provided at intervals in the circumferential direction such that they open in different predetermined directions, as with the plurality of ejection ports 60A. Note that the ejection ports 60D are formed as substantially rectangular through-holes: three are formed in a half region of the main body portion 52 on the bottom portion 52a side, and three are formed in the other half region on the flange portion 54 side. The ejection ports 60D formed in the half region on the bottom portion 52a side and those formed in the other half region on the flange portion 54 side are arranged at staggered positions relative to each other in the circumferential direction. Even with such a plurality of ejection ports 60D, liquid fuel from the pressure regulator 40 can be diffused and discharged through the ejection ports 60D in directions other than toward the liquid surface LS, as in the first embodiment. This can suppress the direct flow of the liquid fuel onto the liquid surface LS, thereby suppressing the generation of bubbles near the liquid surface LS.

### Fifth embodiment

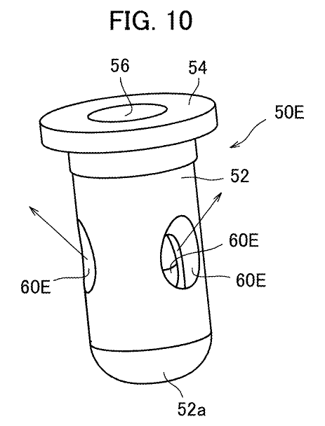

FIG. 10 is a perspective view of a cap 50E of a fifth embodiment. The cap 50E has a plurality of (i.e., three) ejection ports 60E instead of the plurality of ejection ports 60A of the first embodiment. The plurality of ejection ports 60E are provided at intervals in the circumferential direction such that they open in different predetermined directions, as with the plurality of ejection ports 60A. Note that the inner peripheral surface of each ejection port 60E extends upward from the radially inner side toward the radially outer side. That is, each ejection port 60E opens in an obliquely upward direction in a state where the cap 50E is attached. Even with such a plurality of ejection ports 60E, liquid fuel from the pressure regulator 40 can be diffused and discharged through the ejection ports 60E in directions other than toward the liquid surface LS, as in the first embodiment. This can suppress the direct flow of the liquid fuel onto the liquid surface LS, thereby suppressing the generation of bubbles near the liquid surface LS. In particular, as indicated by solid arrows in the drawing, the liquid fuel can be ejected through the ejection ports 60E in obliquely upward directions, which allows the liquid fuel to hit structural elements such as the ceiling portion 141 of the upper case 14 or components arranged near it.

The embodiments have been described above, but the aspects of the present invention are not limited thereto. For example, the VST 1 may have a vent passage for allowing the internal space to communicate with the external space. In addition, the VST 1 may have a float mechanism including a float that oscillates according to the level of the liquid surface LS, and an opening/closing valve that opens and closes in response to the oscillation of the float, thereby enabling the regulation of the inflow amount of liquid fuel to be supplied into the VST 1 with the float mechanism. Further, the shape, number, and opening direction of each of the ejection ports 60A to 60E may be adjusted as appropriate according to the desired ejection direction and ejection flow rate of liquid fuel.

### REFERENCE SIGNS LIST

1 VST (Vapor Separator Tank)
10 casing
12 lower case
14 upper case
16 fuel storage chamber
20 first pump (i.e., pump)
30 second pump (i.e., pump)
40 pressure regulator
42 return port
50A, 50B, 50C, 50D, 50E cap
52 main body portion
52a bottom portion
54 flange portion
56 cap internal flow path
60A, 60B, 60C, 60D, 60E ejection port
144 first boss portion (i.e., boss portion)
144a first discharge flow path
145 second boss portion (i.e., boss portion)
145a second discharge flow path
150 housing portion
151 flow path
152 opening portion
LS liquid surface

What is claimed is:

1. A vapor separator tank for separating gas from liquid fuel to be supplied to an internal combustion engine, comprising:
a casing in which a fuel storage chamber that stores the liquid fuel is formed;
a pump that pressure-feeds the liquid fuel stored in the fuel storage chamber;
a pressure regulator that returns a part of the liquid fuel, pressure-fed by the pump, back to the fuel storage chamber according to discharge pressure of the pump;
a flow path formed in the casing, the flow path communicating with a return port of the pressure regulator, and having an opening portion opening toward a liquid surface of the liquid fuel stored in the fuel storage chamber; and
a hollow cap detachably mounted within the flow path, the hollow cap projecting from the opening portion toward the fuel storage chamber, and communicating with the flow path,
wherein:
at least one ejection port opening in a direction other than toward the liquid surface of the liquid fuel is formed in the cap.

2. The vapor separator tank according to claim 1,
wherein:
the cap includes a bottom-closed cylindrical main body portion, and a flange portion projecting radially outward from the main body portion,
the main body portion is inserted into the flow path such that the main body portion protrudes toward the fuel storage chamber via the opening portion, and
the flange portion is placed on a peripheral edge portion of the opening portion.

3. The vapor separator tank according to claim 1, wherein the ejection port includes a plurality of ejection ports that are formed to open in different predetermined directions.

4. The vapor separator tank according to claim 1, wherein the ejection port is a single opening that opens in a predetermined direction.

5. The vapor separator tank according to claim 1, wherein the ejection port opens in an obliquely upward direction.

6. The vapor separator tank according to claim 1,
wherein:
the casing has a boss portion which extends downward from a ceiling portion and in which a discharge flow path communicating with a discharge port of the pump is formed,
the cap is arranged close to the boss portion, and
at least a part of the ejection port opens toward the boss portion.

7. The vapor separator tank according to claim 2, wherein the ejection port includes a plurality of ejection ports that are formed to open in different predetermined directions.

8. The vapor separator tank according to claim 2, wherein the ejection port is a single opening that opens in a predetermined direction.

9. The vapor separator tank according to claim 2, wherein the ejection port opens in an obliquely upward direction.

10. The vapor separator tank according to claim 2,
wherein:
the casing has a boss portion which extends downward from a ceiling portion and in which a discharge flow path communicating with a discharge port of the pump is formed,
the cap is arranged close to the boss portion, and
at least a part of the ejection port opens toward the boss portion.
